(19) United States
(12) Patent Application Publication
(10) Pub. No.: US 2004/0193871 A1
(43) Pub. Date: Sep. 30, 2004

(54) System and method for transmitting data using selective partial encryption

(75) Inventor: Nambi Seshadri, Irvine, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation, Irvine, CA

(21) Appl. No.: 10/810,688

(22) Filed: Mar. 29, 2004

Related U.S. Application Data
(60) Provisional application No. 60/457,932, filed on Mar. 28, 2003.

(51) Int. Cl. H04K 1/00

(52) U.S. Cl. 713/154; 380/28

(57) ABSTRACT

Particular portions of a message receive strong encryption while other parts of the message are less strongly encrypted or even unencrypted, resulting in a differentially encrypted data set. The data set is transmitted to a receiving end where it may be decrypted as desired. Receiving stations requiring the encrypted information and having authorized access may decrypt it, while other stations may decrypt this information only partially or not at all. Required computational power is reduced both on the client side and in channel processing because only selected portions of the message are subject to strong encryption and decryption processing, and latency and problems associated with latency are reduced.

This application claims the benefit of U.S. Provisional Patent Application Serial No. 60/457,932, filed Mar. 28, 2003, the entire disclosure of which is incorporated herein by reference.

### BACKGROUND OF THE INVENTION

1. Field of the Invention

The present invention relates generally to data transmission and more specifically to a system and method for increasing data transmission efficiency by selecting particular portions of a message for strong encryption while other parts of the message are less strongly encrypted or even unencrypted.

2. Related Art

Encryption is the process of scrambling stored or transmitted information so that it cannot be interpreted until unscrambled by the intended recipient. Cryptography is based on the use of algorithms and a “key” to scramble (encrypt) the original message into unintelligible babble and decrypt the message at the other end. In the field of data transmission, cryptography is typically achieved by digital electronic processing applied at one end of the transmission channel to encrypt the data, and at the other end to decrypt the data.

Symmetric algorithms use the same key to encrypt the data and to decrypt it. Asymmetric or “public key” encryption algorithms require two keys, an unguarded public key used to encrypt the data and a guarded private key used for decryption. The two keys used in asymmetric encryption are mathematically related but cannot be deduced from one another.

A variety of encryption algorithms are available. The most commonly used symmetric techniques are the Data Encryption Standard (DES), a United States federal standard, and the International Data Encryption Algorithm (IDEA). Commonly used asymmetric encryption algorithms include RSA, Pretty Good Privacy (PGP), Secure Sockets Layer (SSL), and Secure Hypertext Transfer Protocol (S-HTTP).

These techniques are applied in various applications to achieve different data protection objectives. For example, encryption may be applied to prevent unauthorized reception of information that is proprietary or confidential, such as business data, banking and credit card information, or personal conversations carried in a digital wireless telephone system. Encryption is also widely used to protect income derived from information subscriptions by preventing non-subscribers from obtaining the data in useful form. For example, premium information channels in digital cable and satellite television systems are generally encrypted and decryption capability is provided only to those subscribers who have paid to view those channels.

A particular level of encryption, varying from “strong” to “weak,” is normally selected for an application depending on the level of security required. One measure of the strength of encryption is the number of bits contained in the encryption key; 128-bit encryption is presently viewed as secure relative to the processing capacity now available to would-be code breakers.

FIG. 1 shows a conventional system and method for transmitting data over a transmission channel in encrypted form. The system includes an encryption processor 104, a transmitter 108, a channel 110, a receiver 112, and a decryption processor 114. Encryption processor 104 has an input to receive data from a data source (not shown) and an output connected to transmitter 108. Transmitter 108 has a transmission output connected to channel 110 that is a conventional wired or wireless data transmission channel. A reception input of receiver 112 is connected to channel 110 to receive data therefrom. Receiver 112 has a received data output that is connected to decryption processor 114. An output of decryption processor 114 is connected to a data receiving device (not shown) which receives the transmitted data.

In operation, an unencrypted data set 102 is supplied to an encryption processor 104. Encryption processor 104 encrypts the entirety of data set 102 to produce encrypted data set 106. Encrypted data set 106 is then supplied to transmitter 108 that transmits data set 106 over channel 110 to receiver 112. Receiver 112 provides the received (encrypted) data set 106 to decryption processor 114 which decrypts data set 106 to produce a duplicate of unencrypted data set 102.

Encryption of transmitted data requires additional digital processing both before and after transmission in the form of encryption processor 104 and decryption processor 114. The computational burden associated with this processing, and the costs associated with this burden, become increasingly significant as the volume of data and the strength of encryption increase. Conventional systems must thus incorporate added processing capacity, and users are inevitably subjected to increases in latency (the time it takes for a packet to cross a network connection, from sender to receiver) to support full encryption of data and thereby maintain data security.

Because of the increasing volume of transmitted data that must be protected during transmission, there is a need for an improved method of encrypting and transmitting data in a secure fashion.

### SUMMARY OF THE INVENTION

The present invention solves the above-identified problems in conventional systems by selecting particular portions of a message for strong encryption while other parts of the message are less strongly encrypted or even unencrypted. The resulting differentially encrypted data set is transmitted to a receiving end where it may be decrypted as desired. In some embodiments, the encrypted information is only selectively decrypted at the receiving end. Receiving stations requiring the encrypted information and having authorized access may decrypt it, while other stations may decrypt this information only partially or not at all.

Selective partial encryption of a data set for transmission as disclosed herein produces multiple benefits. First, required computational power is reduced both on the client side and in channel processing if only selected portions of the message are subject to strong encryption and decryption processing. Another valuable benefit of selective encryption is a reduction of latency and problems associated with latency.

Further embodiments, features, and advantages of the present inventions, as well as the structure and operation of the various embodiments of the present invention, are described in detail below with reference to the accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a schematic diagram showing a system and process used conventionally for data encryption;

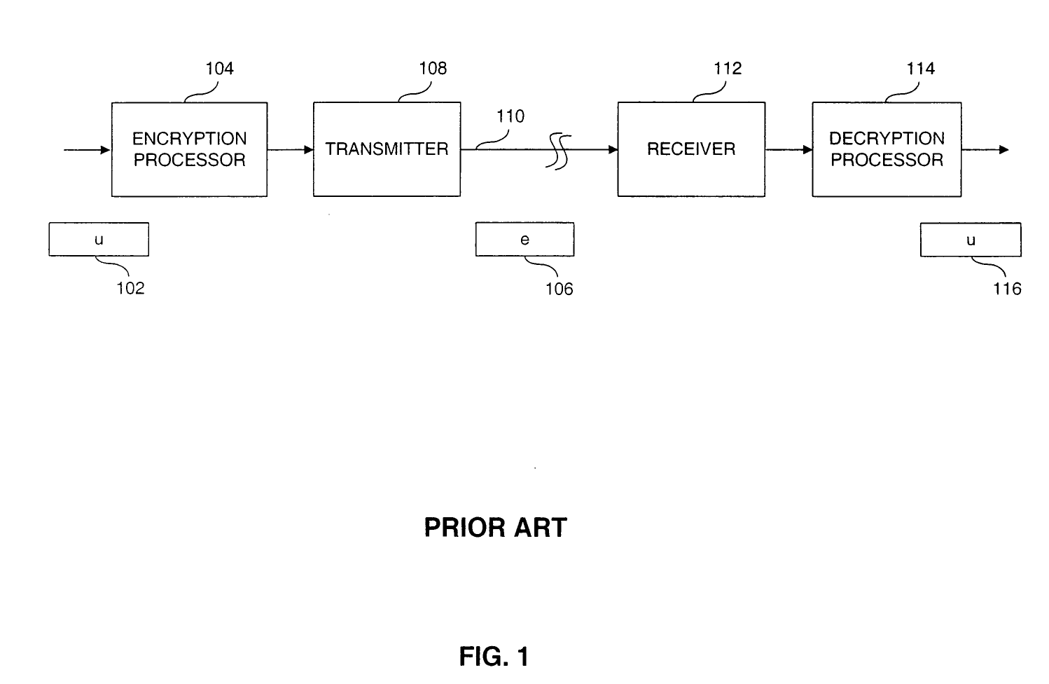

FIG. 2a is a schematic diagram of an embodiment of the invention wherein a portion of a data set is encrypted for transmission and that portion is decrypted upon reception;

FIG. 2b is a schematic diagram of an embodiment of the invention wherein a portion of a data set is encrypted for transmission and that portion is not decrypted upon reception;

FIG. 2c is a schematic diagram of an embodiment of the invention wherein a portion of a data set is encrypted for transmission and only a subset of the encrypted portion is decrypted upon reception;

FIG. 2d is a schematic diagram of an embodiment of the invention wherein strong encryption is applied to a first portion of a data set, a relatively weaker level of encryption is applied to another portion of the data set for transmission, and the weaker-encrypted portion is decrypted upon reception;

FIG. 2e is a schematic diagram of an embodiment of the invention wherein strong encryption is applied to a first portion of a data set, a relatively weaker level of encryption is applied to another portion of the data set for transmission, and the entire message is decrypted upon reception;

FIG. 2f is a schematic diagram of an embodiment of the invention wherein differentially encrypted portions of a data set are transmitted in alternating frames or sets of frames;

FIG. 2g is a schematic diagram of an embodiment of the invention providing bi- directional data transmission;

FIG. 3 is a flow chart showing an embodiment of the invention useful in wireless telephony; and

FIG. 4 is a flow chart showing an embodiment of the invention useful in subscription television applications.

### DETAILED DESCRIPTION OF THE PREFERRED EMBODIMENTS

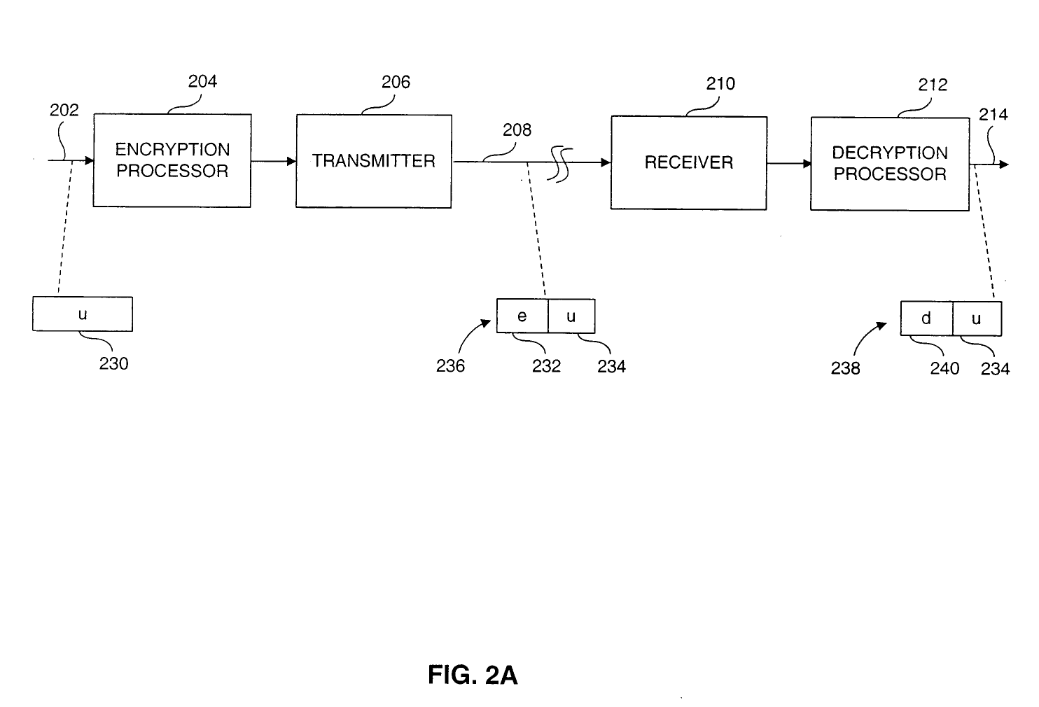

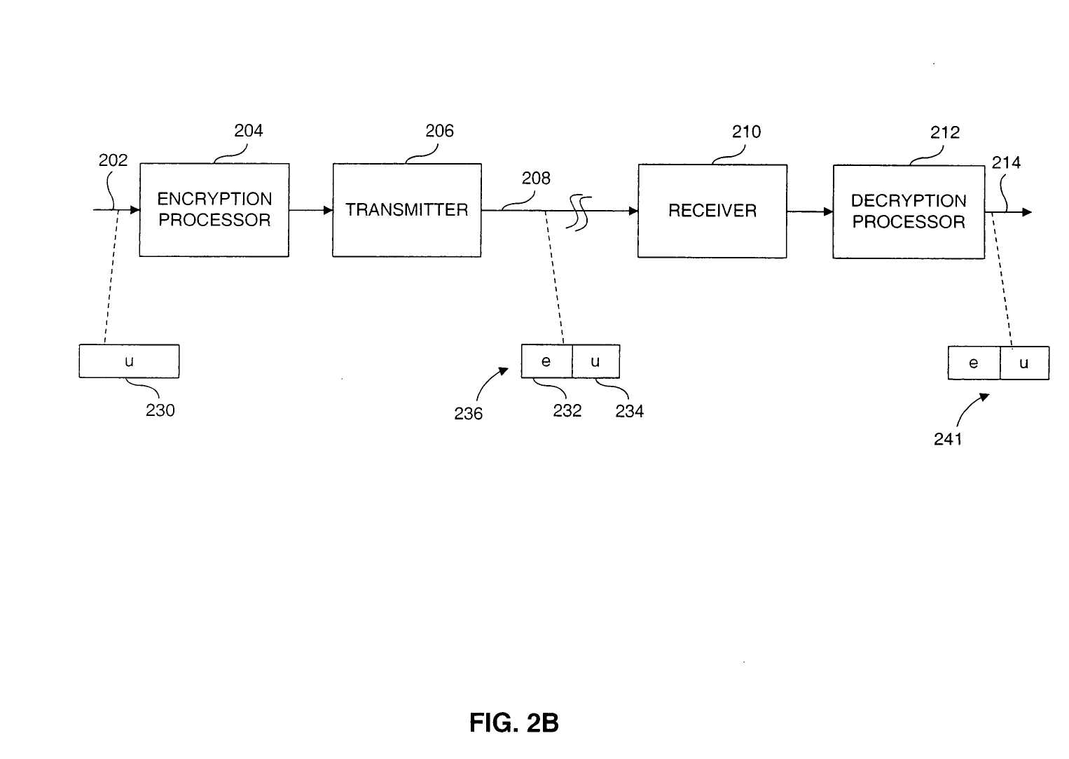

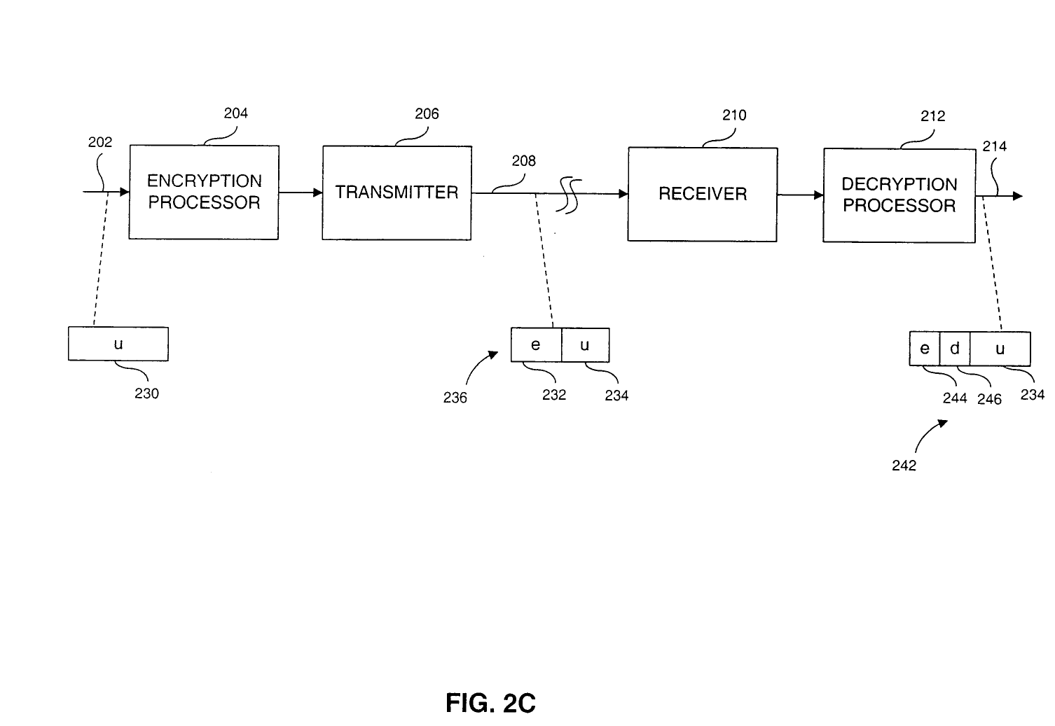

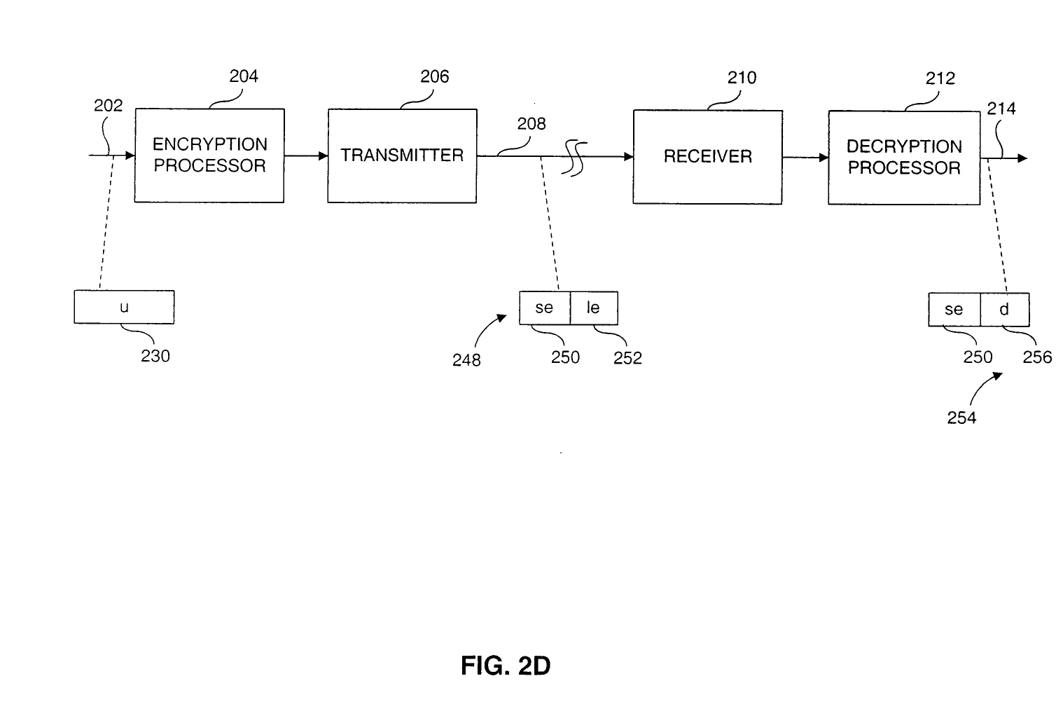

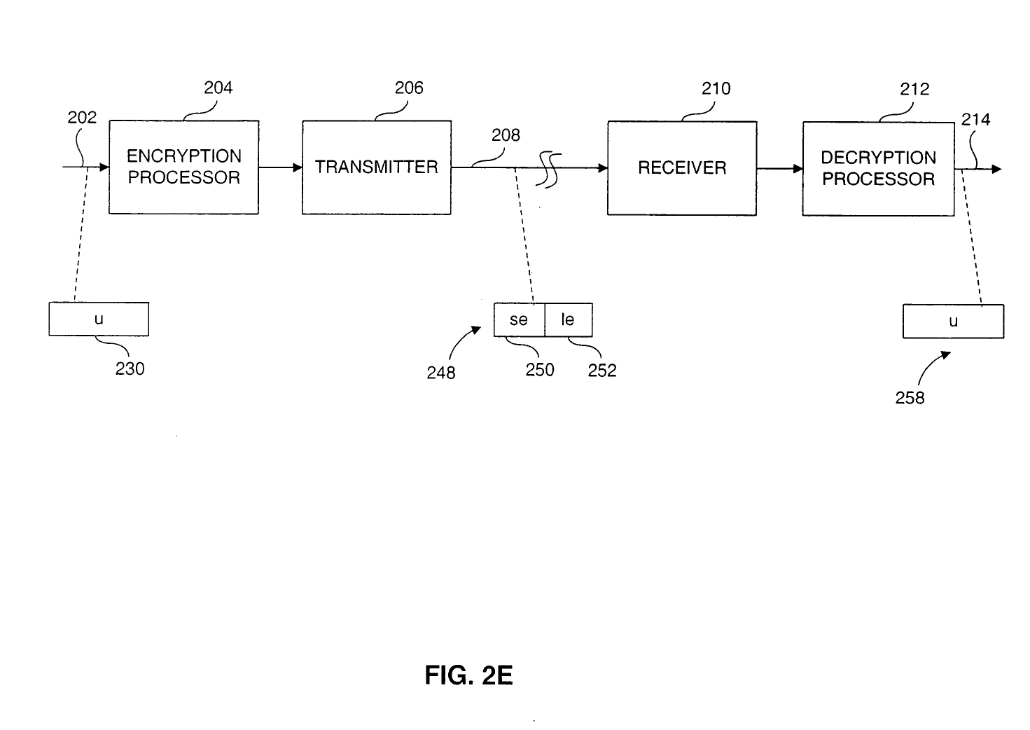

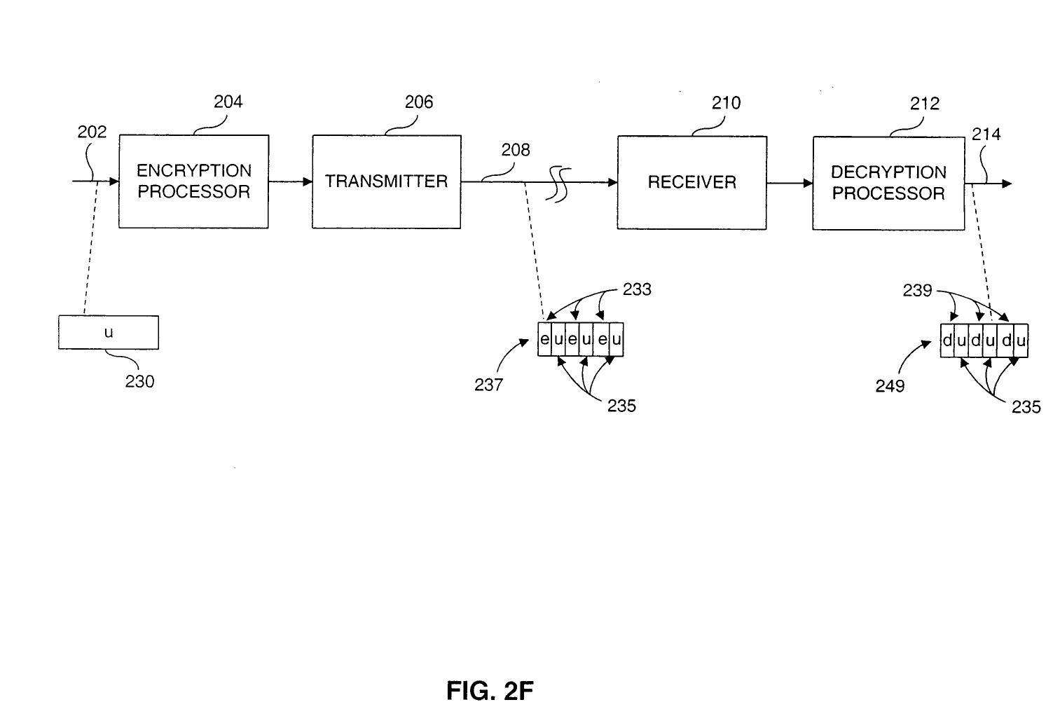

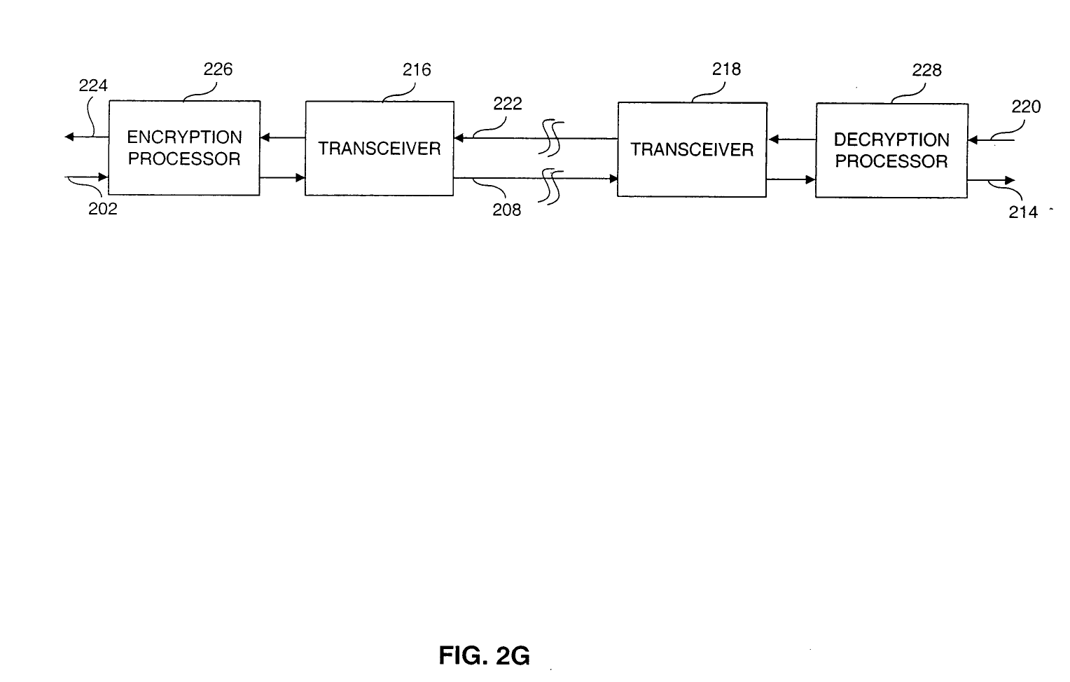

The invention will be introduced generally by reference to FIGS. 2a through 2g. FIGS. 2a through 2g are schematic diagrams of an inventive system for encrypting a first portion of a data set with one level of encryption, while a lesser level of encryption (or in some cases no encryption) is applied to a second portion of the data set. The portions of the data belonging to the first and second portions are selected according to the application to maximize processing and transmission efficiencies while restricting access to important portions of the data.

FIGS. 2a through 2f show, in block schematic form, a basic hardware implementation for transmitting data using the inventive methods disclosed herein. The circuits shown include a data input 202, an encryption processor 204, a transmitter 206, a transmission channel 208, a receiver 210, a decryption processor 212, and a data output 214. Encryption processor 204 receives data to be transmitted from data input 202 and is operably connected to provide a selectively encrypted data output to transmitter 206. Transmission channel 208 conveys data between an output of transmitter 206 and an input of receiver 210. Receiver 210 is connected to provide received data to decryption processor 212. An output of decryption processor 212 is connected to data output 214. Depending on the embodiment of the invention, decryption processor 212 may provide a data stream which is unprocessed, decrypted, or partially decrypted to a data output 214. Any desired processing or transmission device can be connected to data output 214 to receive the data stream from decryption processor 212.

Encryption processor 204 and decryption processor 212 are configured to use the same encryption algorithm for selectively encrypting and decrypting data transmitted over transmission channel 208. The encryption algorithm selected may be any desired encryption algorithm, whether generally known or secret. Examples of appropriate encryption algorithms include, without limitation: symmetric algorithms, asymmetric algorithms, Data Encryption Standard (DES), International Data Encryption Algorithm (IDEA), RSA, Pretty Good Privacy (PGP), Secure Sockets Layer (SSL), and Secure Hypertext Transfer Protocol (S-HTTP). The term “encryption” is used broadly herein to mean any procedure or method used to alter a data set so that it cannot be directly interpreted by unauthorized persons. Thus, “encryption” as used herein encompasses a wide variety of technologies, ranging from the state-of-the-art encryption algorithms discussed above to simple substitution codes, and including all other methods, both simple and complex, of preventing a casual user from viewing a message. As a non-limiting example of a simple form of encryption, ASCII text messages are often encoded to make them unreadable to the casual viewer. In this method, an arbitrary number is added to the value of each data byte in the message, producing garbage text, and the same number is subtracted from each byte value to “decrypt” the message. For example, the most significant bit of each character may be set (equivalent to adding 128 to each character data value) and then cleared to make the message readable in ASCII format.

Transmission channel 208 may be any data transmission channel or may include a plurality of similar or disparate channels. As non-limiting examples, the channel or channels used may include: a hard-wired channel, public switched telephone network channel, land- or satellite-based wireless channel, Internet or other public or private network channel, LAN, WAN, a transmission path from a computing device to a disk drive, memory, or other storage device, or a combination of these or other known channels.

FIG. 2a is a schematic diagram of a system that encrypts a portion of a data set for transmission and decrypts that encrypted portion upon reception. As shown in FIG. 2a, a data set 230 is transferred from an arbitrary data generating device (not shown) to data input 202 of encryption processor 204. In this embodiment, encryption processor 204 generates from data set 230 a partially encrypted data set 236. Partially encrypted data set 236 comprises a first, encrypted portion 232 (represented by “e” for encrypted) containing information from data set 230 and a second, unencrypted portion 234 (represented by “u” for unencrypted) containing information from data set 230.

The portions 232 and 234 to be encrypted and unencrypted respectively are selected according to the application, taking into account the type of data to be transmitted and the level of security desired for those portions of data. The relative proportions of data set 230 included in portions 232 and 234 respectively are also determined based on the application. Preferably the data to be encrypted is selected carefully to minimize the amount of encrypted data while maintaining a required level of security for the transmission. Encrypting a relatively smaller proportion of data set 230 is advantageous in that the processing burden on both encryption processor 204 and decryption processor 212 will be reduced and data overhead on transmission channel 208 may also be favorably reduced. In one embodiment of the invention the proportion of data that is to be encrypted and data that is to be less strongly encrypted or unencrypted varies dynamically during operation of the system. As non-limiting examples, variation may be introduced to compensate for varying channel characteristics or bandwidth availability, to increase transmission security, or based on the changing nature of the information transmitted and/or the existence and terms of a subscription by the receiver to the information being transmitted at that time.

Partially encrypted data set 236 is transmitted over transmission channel 208 to receiver 210 and decryption processor 212. In this embodiment, decryption processor 212 decrypts encrypted portion 232 to produce a decrypted portion 240 (represented by “d” for decrypted) and does not perform any decryption on unencrypted portion 234. A decrypted output data set 238 is provided at output 214. As illustrated in FIG. 2a, decrypted output data set 238 thus comprises decrypted portion 240 and unencrypted portion 234. This embodiment is useful in applications where the recipient is entitled to, or requires, access to the entire transmitted data set.

FIG. 2b shows a further embodiment of the invention wherein a portion of a data set is encrypted for transmission and that portion is not decrypted upon reception by decryption processor 212. As in FIG. 2a, in the embodiment of FIG. 2b a partially encrypted data set 236 comprising encrypted data portion 232 and unencrypted data portion 234 is transmitted over transmission channel 208 to receiver 210. However, decryption processor 212 does not decrypt encrypted data portion 232. An output data set 241 is provided at data output 214, comprising unencrypted data portion 234 and encrypted data portion 232. Thus encrypted data portion 234 is provided in usable form at output 214 while encrypted data portion 232 remains encrypted. In the absence of further processing by another device encrypted data portion 232 cannot be used at the receiving end.

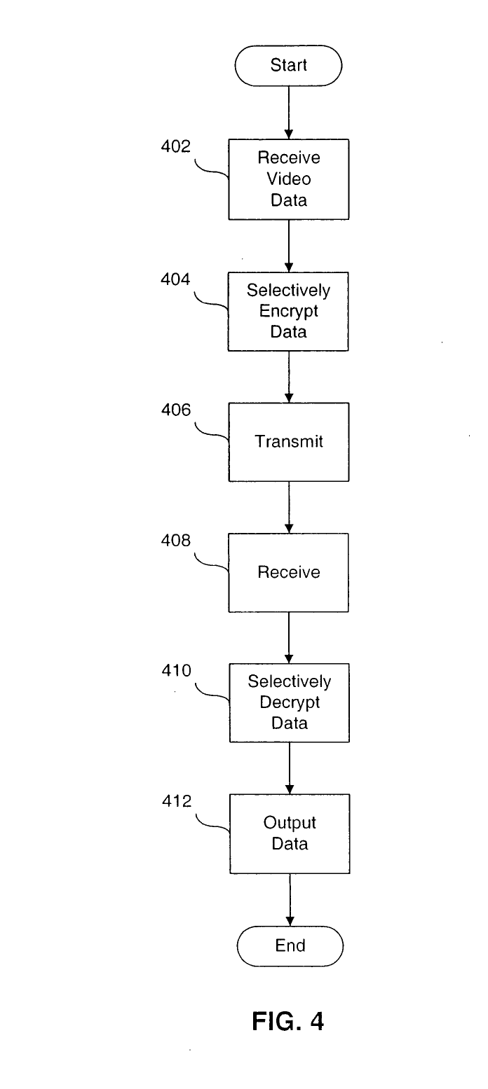

This embodiment is particularly appropriate for applications where the encrypted portion 232 of the data will not be used at the receiving location. For example, in one embodiment unencrypted portion 234 is standard NTSC, PAL, or SECAM video signal data, and encrypted portion 232 is high definition video data (HDTV). Decryption processing of encrypted portion 234 at the receiving end can be omitted if the user is not an HDTV subscriber, or if the equipment connected to output 214 is a standard TV monitor and therefore incapable of processing and displaying HDTV images. In one implementation of this embodiment, base standard video data is transmitted in unencrypted form while high definition video data is transmitted in encrypted form. The high definition video data may be transmitted in incremental form so that displaying a complete HDTV image requires access to both the base signal and the high definition data. All recipients of the signal receive the standard video signal, and those recipients who have subscribed to a high definition service are further provided with a decryption key to facilitate receiving, processing and displaying the high definition data. Embodiments of the invention useful in video processing are described in more detail below, with reference to FIG. 4.

FIG. 2c illustrates yet another embodiment of the invention wherein a portion of a data set is encrypted for transmission and only a subset of the encrypted portion is decrypted upon reception. As in FIGS. 2a and 2b, partially encrypted data set 236 comprising encrypted data portion 232 and unencrypted data portion 234 is transmitted over transmission channel 208 to receiver 210. Decryption processor 212 selectively decrypts a portion 246 of encrypted data portion 232 and produces an output data set 242 comprising decrypted subset 246, encrypted subset 244, and unencrypted portion 234. This embodiment is appropriate for applications where the receiving location is to have access to part, but not all, of the encrypted data portion 232.

FIG. 2d shows a further embodiment of the invention wherein strong encryption is applied to a first portion of a data set, a relatively weaker level of encryption is applied to another portion of the data set for transmission, and the weaker-encrypted portion is decrypted upon reception. In this embodiment, encryption processor 204 processes data set 230 to generate an encrypted data set 248. Encrypted data set 248 comprises a first encrypted portion 250 (represented by “se” for Strong Encryption) and a second encrypted portion 252 (represented by “le” for Less Encryption. Encrypted portion 252 (“le”) is encrypted less strongly than encrypted portion 250. The levels of encryption applied to portions 250 and 252 respectively are selected to provide advantages in the context of the application and its particular requirements. For example, portion 250 may be encrypted using 128-bit public key encryption while portion 252 may be encrypted with a less strong form of encryption, such as 32-bit encryption or a simple substitution code.

In this embodiment, decryption processor 212 decrypts only the less-strongly encryption portion 252 to produce a decrypted portion 256. The result is an output data set 254 at output 214 comprising strongly encrypted portion 250 and decrypted portion 256. It should be noted that a subset, rather than all, of either or both of portions 252 and 256 may be decrypted if desired in the manner described previously with reference to FIG. 2c.

Portions 250 and 252 to be encrypted and less-strongly encrypted respectively are selected according to the application, taking into account the type of data to be transmitted and the level of security desired for those portions of data. The relative proportions of data set 248 included in portions 250 and 252 respectively are also determined based on the application. Preferably the data to be encrypted is selected carefully to minimize the amount of encrypted data while maintaining a required level of security for the transmission. Encrypting a relatively smaller proportion of data set 248 is advantageous in that the processing burden on both encryption processor 204 and decryption processor 212 will be reduced and data overhead on transmission channel 208 may also be favorably reduced. In one embodiment of the invention the proportion of data that is to be encrypted and data that is to be less strongly encrypted or unencrypted varies dynamically during operation of the system. As non-limiting examples, variation may be introduced to compensate for varying channel characteristics or bandwidth availability, to increase transmission security, or based on the changing nature of the information transmitted and/or the existence and terms of a subscription by the receiver to the information being transmitted at that time.

FIG. 2e illustrates another embodiment of the invention wherein strong encryption is applied to a first portion of a data set, a relatively weaker level of encryption is applied to another portion of the data set for transmission, and the entire message is decrypted upon reception. Encryption processor 204 processes data set 230 to generate an encrypted data set 248. Encrypted data set 248 comprises a first encrypted portion 250 and a second encrypted portion 252. Encrypted portion 252 is encrypted less strongly than encrypted portion 250. The levels of encryption applied to portions 250 and 252 respectively are selected to provide advantages in the context of the application and its particular requirements. As non-limiting examples, portion 250 may be encrypted using 128-bit public key encryption while portion 252 may be encrypted with a less strong form of encryption, such as 32-bit encryption or a simple substitution code.

Decryption processor 212 decrypts both strongly encryption portion 250 and less-strongly encryption portion 252 to produce a decrypted data set 258. Decrypted data set 258 is provided at output 214. In other embodiments (not shown), portion 252 is decrypted in part rather than in its entirety, portion 256 is decrypted in part rather than in its entirety, or both portions 252 and 256 are decrypted in part rather than in their entirety.

FIG. 2f shows another useful embodiment of the invention in which differentially encrypted data portions are divided into alternating frames or packets for transmission. For simplicity, data set portions that are unencrypted, or that have different levels of encryption, were shown grouped together for transmission in the diagrams of FIGS. 2a-2f. However, according to this aspect of the invention, which is applicable to any of the methods disclosed in the specification and in FIGS. 2a-2g, data set portions having different levels of encryption, or encrypted and unencrypted data set portions, are divided into packets which are transmitted in frames 233 and 235. Frames 233 of a first type, having a first level of encryption represented by “e” in the diagram, are alternated with frames 235 of a second type, having a second level of encryption that is less than the first level of encryption, to make up a message 237. The second level of encryption may be a reduced level of encryption or may be a zero encryption level, that is to say, unencrypted (represented by “u” in FIG. 2f). One or more single frames of the first type may be transmitted in alternating fashion with one or more single frames of the second type. In one embodiment, single frames of the first and second types are transmitted in alternating form. In another embodiment, a plurality of frames of one type are grouped together for transmission, after which one or more frames of the other type is transmitted, followed by another plurality of frames of the one type. Thus, a more strongly encrypted frame or set of frames is transmitted, followed by a less strongly encrypted frame or set of frames, then another more strongly encrypted frame or set of frames, and so on.

The alternating transmission advantageously equalizes processing loads and reduces buffering requirements for encryption processor 204 and decryption processor 212. In the example shown in FIG. 2f, the output 214 of decryption processor 212 is a decrypted data set 249 consisting of alternating sets of one or more frames 239 of type “d” (decrypted) and one or more frames 235 of type “u” (unencrypted).

The portions of the data set included in frames 233 and 235, encrypted and less-strongly encrypted or unencrypted respectively, are selected according to the application taking into account the type of data to be transmitted and the level of security desired for those portions of data. The relative proportions of data set 230 included in portions 233 and 235 respectively are also determined based on the application. Preferably the data to be encrypted is selected carefully to minimize the amount of encrypted data while maintaining a required level of security for the transmission. Encrypting a relatively smaller proportion of data set 230 is advantageous in that the processing burden on both encryption processor 204 and decryption processor 212 will be reduced and data overhead on transmission channel 208 may also be favorably reduced. In one embodiment of the invention the proportion of data that is to be encrypted and data that is to be less strongly encrypted or unencrypted varies dynamically during operation of the system. As non-limiting examples, variation may be introduced to compensate for varying channel characteristics or bandwidth availability, to increase transmission security, or based on the changing nature of the information transmitted and/or the existence and terms of a subscription by the receiver to the information being transmitted at that time.

The form of encryption applied to each frame may be identified by a flag or by a plurality of data bits associated with the frame to facilitate initial identification of those frames requiring decryption processing, and further facilitate actual decryption processing of the frames.

For clarity, FIGS. 2a through 2f show data transmission in a single direction. However, each of the inventive encryption and transmission options disclosed herein, including the options illustrated in FIGS. 2a through 2f, can also be applied in a bi-directional data transmission environment as illustrated in FIG. 2g. In this bi-directional data transmission embodiment, transmitter 206 and receiver 210 are replaced respectively by transceivers 216 and 218. Transmission channel 222, having a transmission direction opposite to that of channel 208, is provided between transceivers 216 and 218 in addition to channel 208. Channel 222 may be any data transmission channel or may include a plurality of similar or disparate channels. As non-limiting examples, the channel or channels used may include: a hard-wired channel, public switched telephone network channel, land- or satellite-based wireless channel, Internet or other public or private network channel, LAN, WAN, or a transmission path from a disk drive, memory, or other storage device to another storage or computing device. Channel 222 may be the same type of channel as channel 208 or may be different.

In the embodiment of FIG. 2g, encryption processor 204 and decryption processor 212 are replaced respectively by encryption/decryption processors 226 and 228. The method of encryption applied may be the same in each direction in the embodiment of FIG. 2f or different types of encryption may be applied in each direction. Any of the options disclosed herein, including those shown in FIGS. 2a-2f and described above with reference to those figures, can be used in bi-directional transmission or may be combined to create a bi-directional transmission system with different encryption methods used in different directions of transmission.

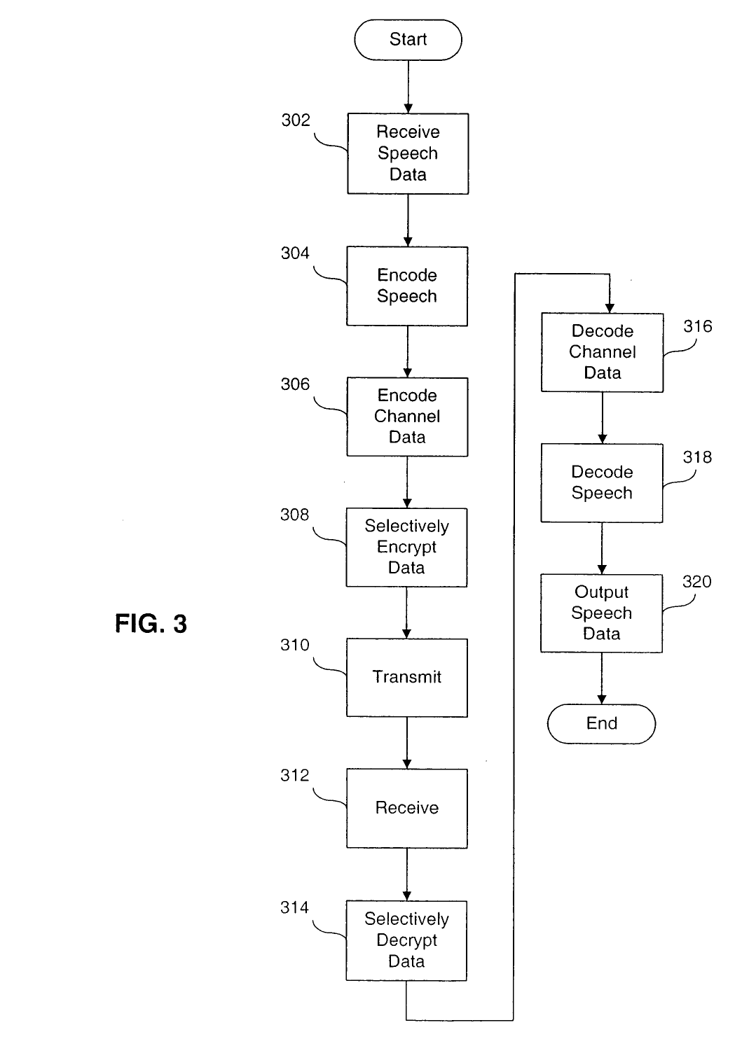

FIG. 3 illustrates a process for wireless telephony according to an embodiment of the invention. The process begins at block 302 with the receipt of speech data from a data source. This source may be, for example, a microphone generating signals in real time. Next, in block 304, the speech data is encoded using a speech codec. The message is then modified for transmission through the channel as shown in block 306. Additional channel data is added to the message to provide redundancy bits useful in detecting and correcting, if possible, errors occurring during the transmission. The data may be interleaved to improve error correction performance and assembled in appropriate data frames for transmission. An example of this process is the burst assembly process in time division multiple access (TDMA) systems.

In block 308, the data is selectively encrypted to protect signaling and user data. The encryption performed is a selective encryption of the data and preferably a strong level of encryption is applied to part, but not all, of the data set. The partial encryption may be accomplished by any of the approaches described above with reference to FIGS. 2a through 2g. In another embodiment of the invention, a fraction of the speech data sufficient to prevent understanding of an intercepted message is strongly encrypted. In a further embodiment of the invention, multimedia data such as video telephone data is at least partially encrypted to prevent display at the other end of the video portion of the data, unless the sender (or recipient) has agreed to pay for that transmission service.

The speech codec operates according to a set of encoding information defining how speech is encoded by the codec to produce coded speech data. Typically a speech codec operates using a compression-decompression algorithm wherein certain speech patterns are approximated by a predetermined set of digital codes in a code table. In one embodiment of the invention, encoding information, such as codec codes, compression-decompression information, or other encoding information is encrypted and transmitted to the receiving station during call setup. In this manner, the coded speech data can be transmitted without encryption during the call process because part or all of the code table required to decode the encoded speech data is encrypted, preventing persons intercepting the data from decoding it into a usable speech signal.

In conventional digital cellular telephone systems, encryption may be applied to low-power, low-rate speech data signals, such as standard 9.6 kilobit per second signals. Features of the present invention may be applied to these low data rate speech signals to produce valuable benefits. The present invention is even more advantageous as data rates increase due to transmission of multimedia information in place of, or in addition to, speech signals. By partially encrypting the data signal as described above, it is possible to reduce overhead and send data more efficiently. This increased efficiency helps to overcome the limitations of low power channels typically used in mobile communications.

In block 310, the data is transmitted over a channel and in block 312 it is received by a receiving station and then selectively decrypted in block 314. The selective decryption process may be performed depending on the data that was encrypted, using one of the approaches described above with reference to FIGS. 2a through 2g.

In block 316, channel and other overhead data is decoded and processed, and the speech is decoded in block 318 using codec data, either preprogrammed or received from the transmitting station as described above. The receiving station then generates a speech data output in block 320.

The process shown in FIG. 3 reduces computation power required for encryption, and this is particularly advantageous in wireless communications systems such as digital cellular telephone systems. If each packet in the data stream is encrypted, these packets must be decrypted for processing as they are received and processed through the cellular system's digital switches. If only a subset of specifically indicated packets must be decrypted, the processing overhead associated with encryption and decryption in the system infrastructure can be significantly reduced.

FIG. 4 shows an embodiment of the invention useful in subscription television applications. Selective encryption provides significant advantages in the field of video transmission. On-the-fly encryption with variable adjustment may also be applied to a video data stream as part of the inventive process, if desired.

Referring to FIG. 4, the process starts in block 402 as video data is received for processing and transmission. Next, in block 404, the video data is selectively encrypted for transmission. The encryption performed is a selective encryption of the data and preferably a strong level of encryption is applied to part, but not all, of the data set. The remainder of the data set may be provided with a relatively weaker level of encryption or may be transmitted in unencrypted form. This differential encryption may be accomplished using any of the approaches described elsewhere herein, particularly including the approaches described above with reference to FIGS. 2a through 2g.

Selection of portions of the data for strong encryption is preferably carried out to maximize security relative to the nature of subscription agreements for the video signal.

For example, in one embodiment standard NTSC, PAL, or SECAM video signal data is transmitted without encryption or with a code that is relatively less secure, and high definition video data (HDTV) is transmitted with stronger encryption and decryption capability is provided only to subscribers. In this way, a basic signal is provided without charge or as part of a standard subscription, and additional information bandwidth is provided as part of a special added subscription. In a variation of this embodiment the HDTV signal is broken down into standard video data (NTSC, PAL or SECAM) and an additional, differential data set which together with the standard data permits reconstruction of the HDTV signal.

Decryption processing of the encrypted portion at the receiving end can be omitted if the user has not subscribed to the encrypted material, or if the equipment connected has limited capability to process and display the encrypted material. In one implementation of this embodiment, base standard video data is transmitted in unencrypted form while high definition video data is transmitted in encrypted form. The high definition video data may be transmitted in incremental form so that displaying a complete HDTV image requires access to both the base signal and the high definition data. All recipients of the signal receive the standard video signal, and those recipients who have subscribed to a high definition service are further provided with a decryption key to facilitate receiving, processing and displaying the high definition data.

In another embodiment, a video signal is broken into composite signal components, which are differentially encrypted. A standard video signal contains luminance and chrominance components. Luminance information (black and white video information) is carried in a Y signal. Chrominance, or color video information, is made up of Q (purple-green axis) and I (orange-cyan axis) signals. Any one or two of the three signals may be encrypted with a first level of encryption, with the others encrypted at a second, reduced level of encryption. In one preferred embodiment the I-signal, which carries more color information than the Q-signal, is strongly encrypted and the remaining information is encrypted in a manner that requires less processing overhead, such as no encryption.

In block 406, the video information is transmitted. Transmission may use any desired channel. As non-limiting examples, a satellite transmission channel or a cable television channel may be used. The data is received in block 408 and is then selectively decrypted in block 410, after which a data output is provided at block 412. The data output is connected to an appropriate receiving device. In block 408, data that was not encrypted for transmission need not be decrypted. Also, data is preferably not decrypted if the receiving station is not authorized to view it because of security classifications or subscription limitations. Finally, any portions of the encrypted data that is not desired by the recipient need not be decrypted. In this way, encryption and decryption overhead in video signal distribution systems is substantially reduced.

In any of the embodiments described, encrypted data portions may be provided with a distinguishing feature at the frame or packet level showing that the data in question is encrypted. This indicating feature may take the form of a designated flag bit in the packet or frame set to “1” for encrypted packets, or multiple bits may be used to indicate in more detail the specific type and level of encryption applied to the packet or frame. In one embodiment a status change indication is transmitted only when there is a change in the type of encryption applied to the data stream; packets received after the status change indication are then processed according to an indicated mode of encryption until a new status change indication is received. The status change indication may take the form of a modified start or stop bit, a flag, a status change indicating packet, a signal state change, or another indicating signal sufficient to indicate that a different decryption processing method should be applied to subsequent packets. In one embodiment a numeric value is transmitted to indicate a number of packets to be processed according to one encryption algorithm, after which other packets will be processed according to another default algorithm. The indicating feature may, instead of indicating bits, use a detectable difference in signal formatting, packet sequence, or other transmission variation that effectively indicates the algorithm used for encryption of those packets or frames. In another embodiment, the transmitting station sends to the receiving station one or more frames of header information identifying the encrypted parts of the data set and optionally identifying the form(s) of encryption applied to various parts of the data set to facilitate decryption and expedited processing of data not subject to decryption.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

I claim:

1. A method of securely transmitting a message to a receiving device, comprising the steps of:
(a) encrypting a first part of said message with a first level of encryption to produce a first message portion;
(b) processing a second part of said message with a second level of encryption to produce a second message portion, with the second level of encryption selected from the group consisting of: (i) no encryption, and (ii) a level of encryption less strong than said first level of encryption;
(c) transmitting said first and second message portions over at least one transmission channel; and
(e) providing an output at the receiving device including at least one of: at least part of said data from said first part of said message and at least part of said data from said second part of said message.

2. The method of claim 1 including the further step of: determining whether at least part of said first message portion should be decrypted upon receipt, and if so decrypting at least part of said first message portion to produce data from said first part of said message.

3. The method of claim 2 including the further step of: determining whether at least part of said second message portion should be decrypted upon receipt, and if so decrypting at least part of said second message portion to produce data from said second part of said message.

4. The method of claim 1 wherein in step (a) said first part of said message is encrypted with an asymmetric algorithm and said first message portion is decrypted on receipt and provided to the receiving device.

5. The method of claim 1 wherein said first part of said message is encrypted for transmission, said second part of said message is not encrypted for transmission, and neither of said first and second message portions are decrypted upon receipt.

6. The method of claim 1 wherein said first part of said message is encrypted for transmission, said second part of said message is encrypted for transmission with said second level of encryption less strong than said first level of encryption, and said second message portion is decrypted upon receipt.

7. The method of claim 6 wherein said first message portion is decrypted upon receipt.

8. The method of claim 1 wherein said first part of said message is encrypted for transmission, said second part of said message is not encrypted for transmission, and part of said first message portion is decrypted upon receipt.

9. The method of claim 1 wherein said first part of said message is encrypted for transmission with said first level of encryption, said second part of said message is encrypted for transmission with said second level of encryption less strong than said first level, and part of said first message portion is decrypted upon receipt and provided to the receiving device.

10. The method of claim 9 wherein said second message portion is decrypted upon receipt and provided to the receiving device.

11. The method of claim 1 wherein said first message portion and said second message portion are divided into frames and in step (c) frames of said first message portion and frames of said second message portion are alternately transmitted over said at least one transmission channel.

12. The method of claim 1 wherein said message comprises speech data and said transmission channel comprises a mobile telephone system channel.

13. The method of claim 12 wherein a fraction of the speech data sufficient to prevent understanding of an intercepted message is strongly encrypted and transmitted in said first message portion.

14. The method of claim 12 wherein said message includes video telephone data and said video telephone data is at least partially encrypted and is not decrypted upon receipt unless one or more subscribers involved in exchanging the message has agreed to pay for video telephone service.

15. The method of claim 12 including the further steps of:
encoding said speech data to produce a coded data set;
in step (a), encrypting and transmitting in said first message portion encoding data useful in decoding said coded data set;
in step (b), selecting and applying said second level of encryption to said coded data set to form said second message portion;
decrypting said encoding data upon receipt; and
using said encoding data to decode said coded data set to obtain said speech data.

16. The method of claim 14 wherein said encoding step is performed with a speech codec.

17. The method of claim 1 wherein said transmitting step includes the step of transmitting information indicating which portions of the transmission are encrypted.

18. The method of claim 17 wherein said first message portion and said second message portion are comprised of a plurality of frames.

19. The method of claim 18 wherein encrypted frames comprise data indicating a level of encryption applied to said encrypted frames.

20. The method of claim 19 wherein said level indicating data is a frame encryption flag.

21. The method of claim 1 wherein said message comprises video data and said transmission channel comprises a video distribution channel.

22. The method of claim 21 wherein said video distribution channel comprises a cable television distribution channel.

23. The method of claim 21 including the further steps of:
selecting a plurality of key data elements of said video data containing information needed to properly process and display the video data;
in step (a), encrypting and transmitting in said first message portion said key data elements;
in step (b), selecting and applying said second level of encryption to at least some of said video data not designated as key data elements;
decrypting said key data elements upon receipt; and
using data from said key data elements to process and display said video data.

24. The method of claim 23 wherein said key data elements contain I-signal video information.

25. A method of securely transmitting information in a data set, comprising the steps of:
applying an encoding algorithm to the data set to generate a coded data set;
generating encoding data containing data useful in decoding said coded data set;
encrypting said encoding data with a level of encryption different from and stronger than any level of encryption that may be applied to the coded data set, to create an encrypted encoding data set;
using at least one transmission channel, transmitting said encrypted encoding data set and said coded data set to a receiving device;
decrypting said encrypted encoding data set after reception by said receiving device; and
using said encoding data to decode said coded data set to obtain transmitted information.

26. The method of claim 25 wherein said encoding data is encrypted using an asymmetric encryption algorithm in said step of encrypting said encoding data.

27. The method of claim 25 wherein said coded data set is transmitted without encryption.

28. The method of claim 25 wherein said encoding algorithm is a compression algorithm.

29. The method of claim 28 wherein said encoding data comprises compression-decompression key information.

30. The method of claim 25 wherein said coded data set comprises digitized voice data in a digital wireless communications system.

31. A method of securely transmitting a message to a receiving device, comprising the steps of:
(a) selecting a first encryption algorithm;
(b) encrypting a first part of said message with said first encryption algorithm to produce a first data set;
(c) selecting a second encryption algorithm from the group consisting of: (i) no encryption, and (ii) those algorithms requiring less processing overhead than required by said first encryption algorithm;
(d) producing from a second part of said message a second data set incorporating encryption to an extent determined by said step of selecting a second encryption algorithm;
(e) generating signals that transmit to a receiving device, over at least one transmission channel, said first and second data sets and information sufficient for said receiving device to determine the type of encryption applied to at least one of said first and second data sets respectively; and
(f) providing an output at the receiving device including at least one of: at least part of said data from said first part of said message and at least part of said data from said second part of said message.

32. The method of claim 31 including the further step of: determining at said receiving device whether at least part of said first data set should be decrypted upon receipt, and if so decrypting at least part of said first data set to produce data from said first part of said message.

33. The method of claim 31 including the further step of: determining whether at least part of said second data set should be decrypted upon receipt, and if so decrypting at least part of said second data set to produce data from said second part of said message.

34. The method of claim 31 wherein said information sufficient for said receiving device to determine the type of encryption applied to at least one of said first and second data sets respectively comprises header information identifying those portions of the transmitted signal to which the first and second encryption algorithms were applied.

35. The method of claim 31 wherein step (e) further includes the step of transmitting to the receiving device information defining at least one of the first and second encryption algorithms.

36. The method of claim 31 wherein in step (e) said first and second data sets are divided into packets and a plurality of said packets are transmitted in frames incorporating said information sufficient for said receiving device to determine the type of encryption applied to at least one of said first and second data sets respectively.

37. The method of claim 36 wherein at least one said frame is transmitted with a flag bit to indicate a level of encryption of the data.

38. A system for securely transmitting a message to a receiving device, comprising:
(a) first processing means for encrypting a first part of said message with a first level of encryption to produce a first message portion;
(b) second processing means for encrypting a second part of said message to produce a second message portion, using a second level of encryption from the group consisting of: (i) no encryption, and (ii) a level of encryption less strong than said first level of encryption;
(c) transmitting means operably connected to said first processing means and said second processing means for transmitting said first and second message portions over at least one transmission channel; and
(e) output means connected to receive information from said transmission channel for providing an output at the receiving device including at least one of: at least part of said data from said first part of said message and at least part of said data from said second part of said message.

39. The system of claim 38 further comprising means for determining whether at least part of said first message portion should be decrypted upon receipt, and if so decrypting at least part of said first message portion to produce data from said first part of said message.

40. The system of claim 39 further comprising means for determining whether at least part of said second message portion should be decrypted upon receipt, and if so decrypting at least part of said second message portion to produce data from said second part of said message.

41. The system of claim 38 wherein said first processing means encrypts said first part of said message with an asymmetric algorithm and said output means further includes means for decrypting said first message portion on receipt for use by the receiving device.

42. The system of claim 38 wherein said first processing means encrypts said first part of said message for transmission, said second processing means uses no encryption for said second part of said message, and said output means provides said first message portion to the receiving device without decrypting said first message portion, whereby said receiving device can process said second part of said message but cannot interpret said first part of said message.

43. The system of claim 38 wherein said first processing means encrypts said first part of said message for transmission, said second processing means encrypts said second part of said message with said second level of encryption less strong than said first level of encryption, and said output means comprises means for decrypting said second message portion upon receipt.

44. The system of claim 43 wherein said output means further comprises means for decrypting said first message portion upon receipt.

45. The system of claim 38 wherein said first processing means encrypts said first part of said message, said second processing means applies no encryption to said second part of said message, and said output means includes means for decrypting a first subset of said first message portion and providing to said receiving device said decrypted first subset of said first message and a second subset of said first message that is not decrypted.

46. The system of claim 38 wherein said first processing means encrypts said first part of said message, said second processing means encrypts said second part of said message with said second level of encryption less strong than said first level, and said output means includes means for decrypting a first subset of said first message portion and providing to said receiving device said decrypted first subset of said first message and a second subset of said first message that is not decrypted.

47. The system of claim 46 wherein said output means comprises means for decrypting said second message portion upon receipt and providing a resulting decrypted second message portion to the receiving device.

48. The system of claim 38 wherein said transmission means comprises means for dividing said first message portion and said second message portion into frames alternately transmitting frames of said first and second message portions over said at least one transmission channel.

49. The system of claim 38 wherein said message comprises speech data and said transmission channel comprises a mobile telephone system channel.

50. The system of claim 49 wherein a fraction of the speech data sufficient to prevent understanding of an intercepted message is encrypted and transmitted in said first message portion.

51. The system of claim 49 wherein said message includes video telephone data and said video telephone data is at least partially encrypted and decrypted upon receipt only if one or more subscribers involved in the message exchange is a video telephone service subscriber.

52. The system of claim 49 further comprising:
means for encoding said speech data to produce a coded data set;
means in said first processing means for encrypting and transmitting in said first message portion encoding data useful in decoding said coded data set;
means in said second processing means for selecting and applying said second level of encryption to said coded data set to form said second message portion;
means in said output means for decrypting said encoding data upon receipt;
whereby said receiving device receives and uses said encoding data to decode said coded data set to obtain said speech data.

53. The system of claim 52 wherein said means for encoding said speech data incorporates a speech codec.

54. The system of claim 38 wherein said transmission means includes means for transmitting information indicating which portions of the transmission are encrypted.

55. The system of claim 54 wherein said transmission means includes framing means for separating said first message portion and said second message portion into a plurality of frames.

56. The system of claim 55 wherein said framing means includes means for adding to said encrypted frames an indication of an applied level of encryption.

57. The system of claim 56 wherein said indication is a frame encryption flag.

58. The system of claim 38 wherein said message comprises video data and said transmission channel comprises a video distribution channel.

59. The system of claim 58 wherein said video distribution channel comprises a cable television distribution channel.

60. The system of claim 58 further comprising:
means for selecting a plurality of key data elements of said video data containing information needed to properly process and display the video data;
means associated with said first processing means for encrypting and transmitting in said first message portion said key data elements;
means associated with said second processing means for selecting and applying said second level of encryption to at least some of said video data not designated as key data elements;
decryption means associated with the output means for decrypting said key data elements upon receipt;
whereby said receiving device is provided with said data from said key data elements and uses said key data to process and display said video data.

61. The system of claim 60 wherein said key data elements contain I-signal video information.

62. A system for securely transmitting information in a data set, comprising:
encoding means for applying an encoding algorithm to the data set to generate a coded data set;
encoding definition means for generating encoding data useful in decoding said coded data set;
encryption means for encrypting said encoding data with a level of encryption different from and stronger than any level of encryption that may be applied to the coded data set, to create an encrypted encoding data set;
transmission means for transmitting said encrypted encoding data set and said coded data set to a receiving device using at least one transmission channel; and
decryption means for decrypting said encrypted encoding data set after reception by said receiving device;
whereby said receiving device receives said encoding data in decrypted form and uses it to decode said coded data set to obtain transmitted information.

63. The system of claim 62 wherein said encryption means uses an asymmetric encryption algorithm.

64. The system of claim 62 wherein said transmission means transmits said coded data set without encryption.

65. The system of claim 62 wherein said encoding algorithm is a compression algorithm.

66. The system of claim 65 wherein said encoding data comprises compression-decompression key information.

67. The system of claim 62 wherein said coded data set comprises digitized voice data in a digital wireless communications system.

68. A system for securely transmitting a message to a receiving device using a first encryption algorithm and a second encryption algorithm selected from the group consisting of: (i) no encryption, and (ii) those algorithms requiring less processing overhead than required by said first encryption algorithm, comprising:
(a) first processing means for encrypting a first part of said message with said first encryption algorithm to produce a first data set;
(b) second processing means for producing from a second part of said message a second data set incorporating encryption to an extent determined by said second encryption algorithm;
(c) transmission means for generating signals for transmission to a receiving device over at least one transmission channel, said signals representing said first and second data sets and information sufficient for said receiving device to determine a type of encryption applied to at least one of said first and second data sets respectively; and
(d) output means for providing an output at the receiving device including at least one of: at least part of said data from said first part of said message and at least part of said data from said second part of said message.

69. The system of claim 68 wherein the output means further includes means for decrypting at least part of said first data set to produce data from said first part of said message.

70. The system of claim 69 wherein the output means further includes means for decrypting at least part of said second data set to produce data from said second part of said message.

71. The system of claim 68 wherein said transmission means further comprises means for generating and transmitting header information identifying those portions of the transmitted signal to which the first and second encryption algorithms were applied.

72. The system of claim 68 wherein said transmission means further comprises means for transmitting to the receiving device information identifying at least one of the first and second encryption algorithms.

73. The system of claim 68 wherein said transmission means further comprises framing means for dividing said first and second data sets into packets and transmitting said packets in frames incorporating said information sufficient for said receiving device to determine the type of encryption applied to at least one of said first and second data sets respectively.

74. The system of claim 73 wherein at least one said frame is transmitted with a flag bit to indicate a level of encryption of the data.
